(19) United States
(12) Patent Application Publication
(10) Pub. No.: US 2016/0114515 A1
(43) Pub. Date: Apr. 28, 2016

(54) KNEADING AND GRANULATING APPARATUS

(71) Applicants: Naochika Asai, Osaka (JP); Motohiro Tanaka, Nara (JP)

(72) Inventors: Naochika Asai, Osaka (JP); Motohiro Tanaka, Nara (JP)

(21) Appl. No.: 14/678,496

(22) Filed: Apr. 3, 2015

(30) Foreign Application Priority Data
Oct. 23, 2014 (JP) 2014-216580

(51) Int. Cl. B29C 47/00; B29C 47/62; B29C 47/60; B29C 47/40

(52) U.S. Cl. CPC B29C 47/0011; B29C 47/402; B29C 47/62; B29C 47/6056; B29K 2105/251

(57) ABSTRACT

Provided is a kneading and granulating apparatus capable of adjusting the hardness of granules to be obtained with simple structure. The kneading and granulating apparatus includes a kneading section and a granulating section. The kneading section includes a first casing and two kneading shaft members. A plate-shaped first screen having a large number of holes formed therein is provided on a distal end portion of the first casing so as to close an opening portion of the first casing on the distal end side. A spacer is provided between the distal end portion of the first casing and the first screen, thereby being capable of changing a separation distance between a distal end portion of a screw portion of the kneading shaft member and the first screen.

### BACKGROUND OF THE INVENTION

1. Field of the Invention

The present invention relates to a kneading and granulating apparatus for kneading a dry powder raw material and a binder solution and granulating the kneaded powder.

2. Description of the Related Art

When producing a compact (granules) from powder, a kneading and granulating machine disclosed in Japanese Patent Application Laid-open No. 2012-125754 may be used. In the kneading and granulating machine disclosed in Japanese Patent Application Laid-open No. 2012-125754, a dry powder raw material and a binder solution are kneaded by a kneading screw while being conveyed by the kneading screw. Then, the kneaded powder is caused to drop into a granulating case so as to be granulated. In the kneading and granulating machine disclosed in Japanese Patent Application Laid-open No. 2012-125754, the kneading and the granulating can be carried out in series, and hence the work efficiency is excellent.

Incidentally, in a case of granules having low hardness, the granules may be powdered after the granulating due to handling or the like, with the result that the yield may be degraded. Therefore, granules having high hardness are required. However, in this case, when producing the granules, it is necessary to carry out the kneading sufficiently so that the binder solution is dispersed homogeneously.

However, in the kneading and granulating machine disclosed in Japanese Patent Application Laid-open No. 2012-125754, in order to carry out the kneading sufficiently, for example, it is necessary to use a longer kneading screw, or to change the shape of the kneading screw or the structure thereof. Thus, the hardness is difficult to adjust.

### SUMMARY OF THE INVENTION

It is an object of the present invention to provide a kneading and granulating apparatus capable of adjusting the hardness of granules to be obtained with simple structure.

In order to achieve the above-mentioned object, according to one embodiment of the present invention, there is provided a kneading and granulating apparatus, including: a first casing; a kneading shaft member arranged horizontally inside the first casing and rotatable so as to knead a raw material while conveying the raw material; a first screen provided on a distal end portion of the first casing with a large number of holes formed in the first screen; a second casing provided on the distal end portion of the first casing; a second screen; and a granulating shaft member arranged vertically inside the second casing and configured to granulate the raw material, which is fed through the first screen, in a portion between the granulating shaft member and the second screen, in which a separation distance between a distal end portion of a screw portion of the kneading shaft member in an axial direction of the kneading shaft member and a plate surface of the first screen is changeable.

According to the one embodiment of the present invention, the kneading and granulating apparatus further includes a plate-shaped spacer, which is provided between a distal end surface of the first casing and the plate surface of the first screen so as to change the separation distance between the distal end portion of the screw portion of the kneading shaft member in the axial direction and the plate surface of the first screen. The plate-shaped spacer has a hole formed therein at a position corresponding to a hole of the first casing, in which the kneading shaft member is arranged.

According to the one embodiment of the present invention, in the kneading and granulating apparatus, the first screen has a thickness of from 0.5 mm to 3.0 mm.

Further, according to the one embodiment of the present invention, in the kneading and granulating apparatus, the granulating shaft member has a round bar shape, a lower end portion of the granulating shaft member is formed so as to be increased in diameter, the granulating shaft member includes a screw-shaped blade formed on an outer circumferential portion of the lower end portion thereof, and the screw-shaped blade is divided at a plurality of positions in a circumferential direction of the granulating shaft member.

According to the kneading and granulating apparatus of the one embodiment of the present invention, it is possible to adjust the hardness of the granules to be obtained with simple structure.

### BRIEF DESCRIPTION OF THE DRAWINGS

FIG. 1 is a schematic partial sectional front view of a kneading and granulating apparatus according to an embodiment of the present invention.

FIG. 2 is a schematic horizontal sectional view of a part of the kneading and granulating apparatus of FIG. 1.

FIG. 3 is an enlarged view of a part of the kneading and granulating apparatus of FIG. 1.

FIG. 4 is a perspective view of a distal end portion of a kneading section of the kneading and granulating apparatus of FIG. 1.

FIG. 5 is an exploded perspective view of the distal end portion of the kneading section of the kneading and granulating apparatus of FIG. 4.

FIG. 6 is a view illustrating a state in which a spacer is mounted on the kneading section of the kneading and granulating apparatus of FIG. 1.

FIG. 7 is an exploded perspective view of the distal end portion of the kneading section of the kneading and granulating apparatus of FIG. 6.

### DETAILED DESCRIPTION OF THE PREFERRED EMBODIMENT

Now, a kneading and granulating apparatus according to an embodiment of the present invention is described in detail with reference to the drawings.

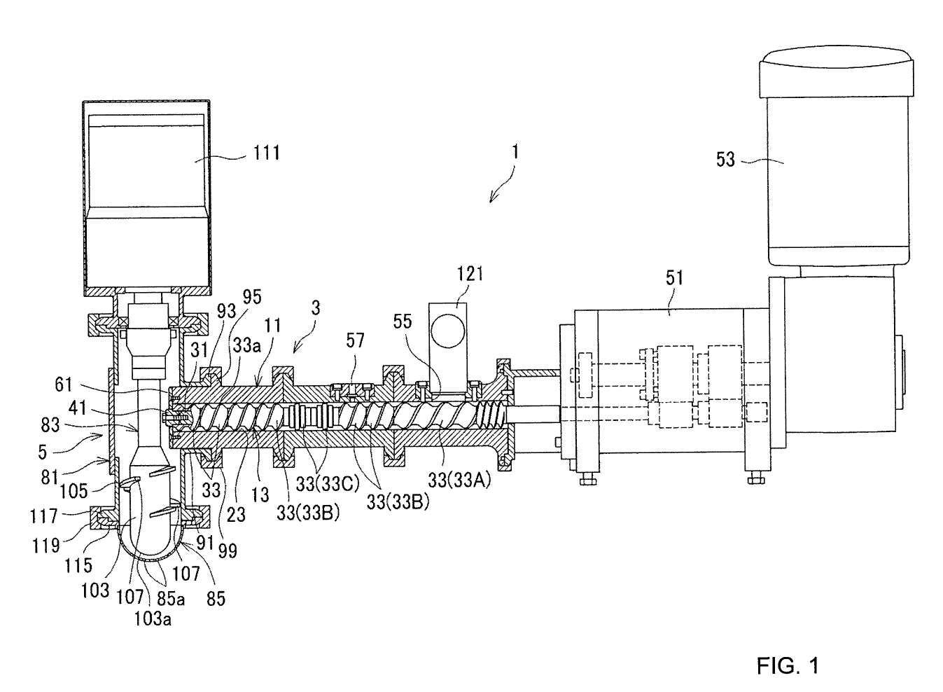

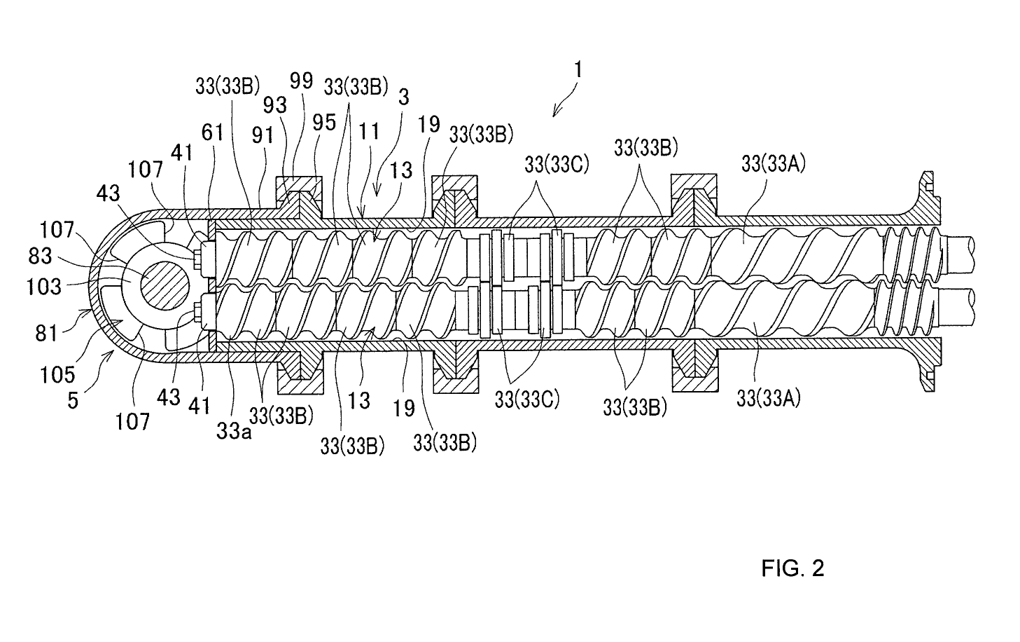

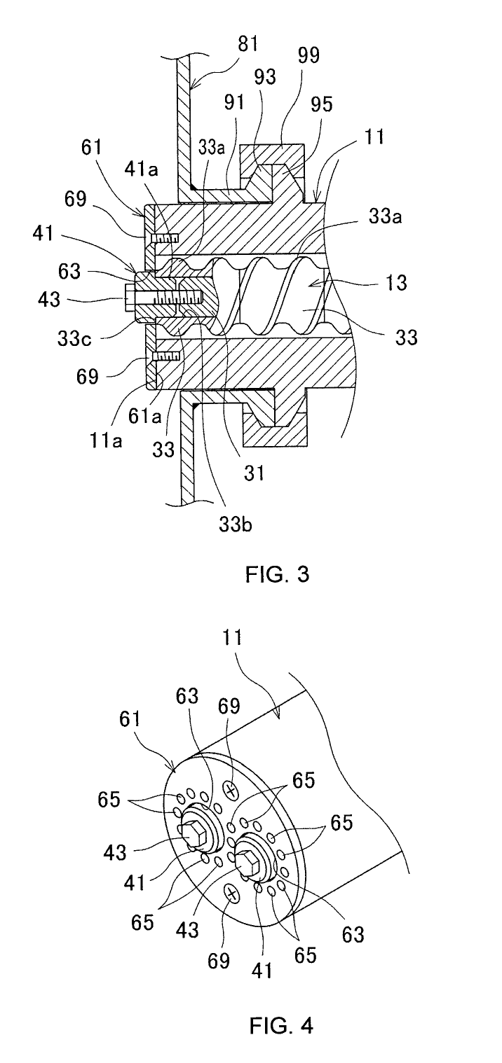

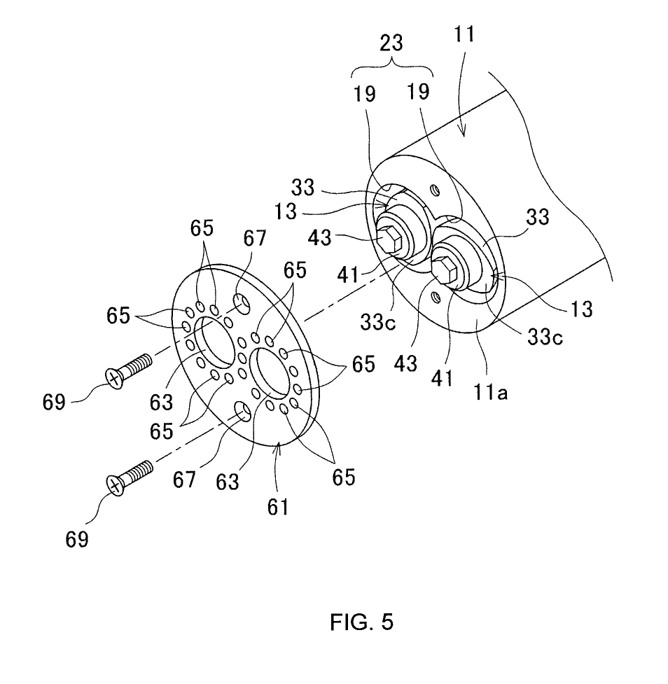

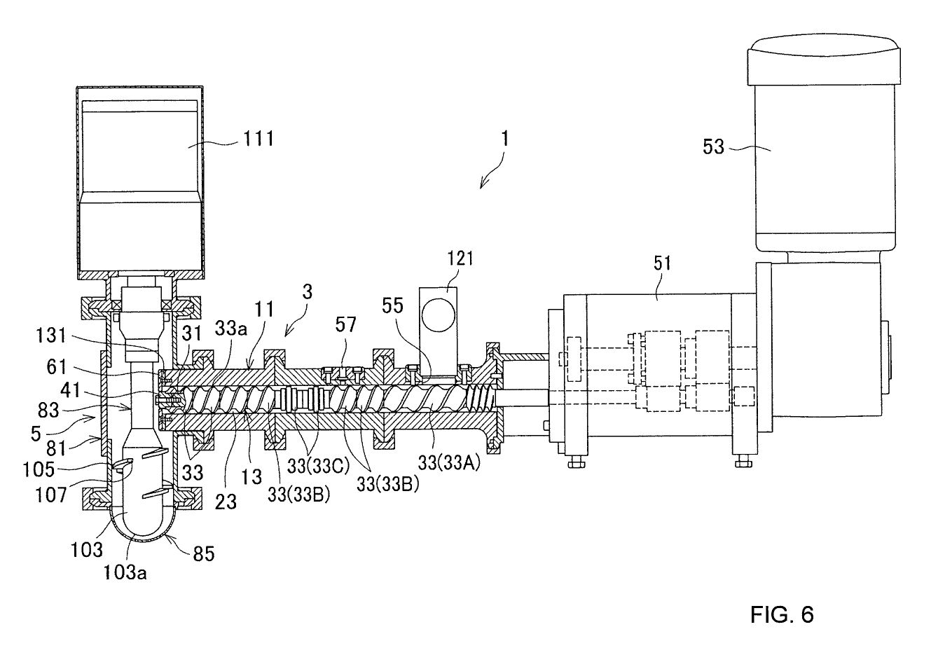

FIG. 1 is a schematic partial sectional front view of the kneading and granulating apparatus according to the embodiment of the present invention. FIG. 2 is a schematic horizontal sectional view of a part of the kneading and granulating apparatus of FIG. 1. FIG. 3 is an enlarged view of a part of the kneading and granulating apparatus of FIG. 1. FIG. 4 is a perspective view of a distal end portion of a kneading section of the kneading and granulating apparatus of FIG. 1. FIG. 5 is an exploded perspective view of the distal end portion of the kneading section of the kneading and granulating apparatus of FIG. 4.

A kneading and granulating apparatus 1 according to this embodiment includes, as main components, a kneading section 3 for kneading a raw material while conveying the raw material, and a granulating section 5 for granulating the raw material kneaded by the kneading section 3.

The kneading section 3 includes a first casing 11 having a hollow box shape, and two kneading shaft members 13, 13 provided inside the first casing 11 so as to be rotatable.

The first casing 11 has a columnar shape and is arranged so that an axial line thereof extends in a horizontal direction. Note that, in the example of the figures, the first casing 11 is formed by coupling a plurality of members to each other so as to be separable from each other, but the first casing 11 may be formed of a single member.

As illustrated in FIG. 5, in a center portion of the first casing 11, two holes 19, 19 having a circular shape in cross-section, in which the kneading shaft members 13, 13 are arranged, are formed so as to extend in an axial direction. The two holes 19, 19 are formed so as to be adjacent to each other in a fore-and-aft direction, and also partially overlap with each other in side view. Thus, the holes 19, 19 are integrally communicated to each other. That is, one hole 19 having a circular shape in cross-section is formed in the first casing 11 so as to extend in the horizontal direction, and the other hole 19 having a circular shape in cross-section is formed so as to extend in the horizontal direction while partially overlapping with the one hole 19. Thus, in the first casing 11, a hole 23 having substantially a shape of the figure of “eight” in a lateral direction is formed by the two holes 19, 19 so as to extend in the axial direction.

The kneading shaft members 13, 13 are arranged in the fore-and-aft direction in the first casing 11 in a horizontal posture. Specifically, each kneading shaft member 13 is arranged in the hole 19 of the first casing 11 so that an axial line thereof extends in the horizontal direction.

A large number of pieces 33 are sequentially fitted on a bar-shaped shaft portion 31 of each kneading shaft member 13.

Projections and depressions are sequentially formed on an outer circumferential portion of the shaft portion 31 into a spline shape in a circumferential direction, and the projections and depressions are formed so as to extend in the axial direction.

The pieces 33 have a cylindrical shape, and outer circumferential portions 33a thereof are formed as a screw. Further, an inner circumferential portion 33b of each of the pieces 33 has a sectional shape that is engageable with the outer circumferential portion of the shaft portion 31. That is, projections and depressions are sequentially formed on the inner circumferential portion 33b of each of the pieces 33 in the circumferential direction, and the projections and depressions are formed so as to extend in the axial direction.

The shaft portion 31 is inserted through an inner hole of each of the pieces 33, and the pieces 33 are sequentially fitted on the shaft portion 31 so as to extend in the axial direction. Under a state in which the pieces 33 are fitted on the shaft portion 31, when the inner circumferential portion 33b of each of the pieces 33 and the outer circumferential portion of the shaft portion 31 are engaged with each other, the shaft portion 31 and the pieces 33 are rotatable integrally with each other.

Under a state in which the kneading shaft member 13 is arranged in each hole 19 of the first casing 11, screws of the kneading shaft members 13, 13 overlap with each other, that is, the kneading shaft members 13, 13 are arranged so as to mesh with each other.

In the example of the figures, the pieces 33 of a plurality types (33A to 33C), which have outer circumferential portions different in shape from one another, are provided on the shaft portion 31 so that the shaft portion 31 is inserted therethrough. In this embodiment, the pieces 33A, 33B having a screw-shaped outer circumferential portion, which mainly function as pieces for conveyance, and the pieces 33C, which mainly function as pieces for kneading, are provided. Blades projecting radially outward into a plate shape are arranged on the pieces 33C with a shift of 45°. The pieces 33C are interposed between the pieces 33B, 33B in a middle portion of the shaft portion 31 in the axial direction.

Under a state in which the pieces 33 are mounted on the shaft portion 31, as illustrated in FIG. 3, the piece 33 provided on a distal end portion of the shaft portion 31 extends beyond the distal end of the shaft portion 31.

A fastener 41 having substantially a columnar shape is provided to the distal end portion of the shaft portion 31. One end portion 41a of the fastener 41 is formed so as to be reduced in diameter.

The one end portion 41a of the fastener 41 is fitted into the inner hole of the piece 33 provided on the distal end portion of the shaft portion 31. Then, a screw 43 is driven from another end portion of the fastener 41 into the distal end portion of the shaft portion 31. Thus, the fastener 41 is fixed to the shaft portion 31. With this, the movement of the piece 33 in the axial direction with respect to the shaft portion 31 is restricted.

Under a state in which the kneading shaft members 13, 13 are arranged in the first casing 11, a distal end portion 33c of the piece 33 provided on the distal end portion of the shaft portion 31 and a distal end surface 11a of the first casing 11 are arranged so as to be flush with each other.

A proximal end portion of each shaft portion 31 is connected to a motor 53 through intermediation of a speed reducer 51, and each shaft portion 31 is rotatable in the same direction.

A first feeding port 55, into which a dry powder raw material is fed, is formed in a proximal end portion of the first casing 11 so as to open upward. Further, a second feeding port 57, into which a binder solution is fed, is formed on the distal end side with respect to the first feeding port 55 so as to open upward.

A plate-shaped first screen 61 is provided on a distal end portion of the first casing 11 so as to close an opening portion of the first casing 11 on the distal end side.

The first screen 61 has a disc shape, and an outer diameter thereof is equal to an outer diameter of the first casing 11. Two holes 63, 63 having a circular shape are formed in a center portion of the first screen 61 so as to be distanced from each other in the fore-and-aft direction. An outer diameter of the hole 63 is substantially equal to an outer diameter of the fastener 41.

A large number of discharge holes 65, which are smaller in diameter than the hole 63, are formed in a periphery of each hole 63. That is, the large number of the discharge holes 65 are formed in the first screen 61 at positions surrounding each hole 63, and hence the first screen 61 is a perforated plate. Note that, in a center portion of the first screen 61, that is, in a portion between the holes 63, 63 formed so as to be adjacent to each other in the fore-and-aft direction, the discharge holes 65 surrounding each hole 63 are shared.

The first screen 61 is assembled to the distal end surface of the first casing 11 in an overlapping manner. Then, screws 69 are driven into the first casing 11 through through-holes 67 respectively formed in two upper and lower positions of the first screen 61. Thus, the screws 69 are fixed to the first casing 11.

Under a state in which the first screen 61 is mounted on the first casing 11, the fastener 41 is inserted through the hole 63 of the first screen 61, and each hole 63 of the first screen 61 and each kneading shaft member 13 are arranged on the same straight line.

Further, the discharge holes 65 of the first screen 61 are formed at positions corresponding to the hole 19 of the first casing 11. That is, under a state in which the first screen 61 is mounted on the first casing 11, the discharge holes 65 of the first screen 61 are positioned within the hole 19 of the first casing 11.

The granulating section 5 includes, as main components, a second casing 81 having a hollow box shape, which is provided on the distal end portion of the first casing 11, a granulating shaft member 83 provided inside the second casing 81 so as to be rotatable, and a second screen 85 for granulating a raw material in a portion between the second screen 85 and the granulating shaft member 83.

The second casing 81 has a cylindrical shape and is arranged so that an axial line thereof extends in a vertical direction. A connecting pipe 91 is provided in a middle portion of the second casing 81 in the vertical direction so as to extend horizontally. A flange portion 93 is formed on a distal end portion of the connecting pipe 91 so as to project radially outward.

A flange portion 95 is formed on the distal end side of the first casing 11 so as to project radially outward.

The connecting pipe 91 of the second casing 81 is fitted on the distal end portion of the first casing 11, and thus the flange portion 93 of the second casing 81 and the flange portion 95 of the first casing 11 are assembled to each other in an overlapping manner. Then, the flange portions 93, 95 are coupled to each other with a joint 99, and thus the casings 11, 81 are removably coupled to each other. In this embodiment, a ferrule clamp is used as the joint 99.

Under a state in which the second casing 81 is mounted on the first casing 11, the distal end portion of the first casing 11 is arranged so as to protrude inside the second casing 81.

The granulating shaft member 83 has a round bar shape and is arranged so that an axial line thereof extends in the vertical direction. A lower end portion 103 of the granulating shaft member 83 is formed so as to be increased in diameter, and further a lower end 103a of the granulating shaft member 83 is formed into a semispherical shape so as to project downward.

A blade 105 is formed into a spiral shape on an outer circumferential surface of the lower end portion 103 of the granulating shaft member 83. Cutout portions 107 are formed in a plurality of positions of the blade 105, which is formed into a spiral shape, in the circumferential direction, and the blade 105 is divided at the plurality of positions.

An upper end portion of the granulating shaft member 83 is connected to a motor 111, and the granulating shaft member 83 is provided vertically inside the second casing 81 so as to be rotatable.

The second screen 85 is removably provided on a lower end portion of the second casing 81. The second screen 85 is formed of a plate material, in which a large number of holes 85a small in diameter are formed, into a semispherical shape, and a flange portion 115 is formed on an outer circumferential portion of the second screen 85 so as to project radially outward.

The flange portion 115 of the second screen 85 is assembled to a flange portion 117 formed on the lower end portion of the second casing 81 in an overlapping manner, and thus the flange portions 115, 117 are removably coupled to each other with a joint 119. In this embodiment, a ferrule clamp is used as the joint 119.

In the kneading and granulating apparatus 1 having such structure according to this embodiment, a dry powder raw material is fed into the first feeding port 55 of the first casing 11 through use of a feeder 121 or the like, and further a binder solution is fed into the second feeding port 57. Then, the kneading shaft members 13, 13 are rotated, and thus the dry powder raw material and the binder solution are kneaded while being conveyed to the distal end side of the first casing 11 (left side in FIG. 1). In this manner, wet powder is obtained.

The wet powder, which has reached the distal end portions of the kneading shaft members 13, 13, passes through the discharge holes 65 of the first screen 61, and then the wet powder drops into the second casing 81.

The wet powder, which has dropped into the second casing 81, is granulated in a portion between the granulating shaft member 83 and the second screen 85, and then the wet powder drops downward through the holes 85a of the second screen 85 so as to be collected.

In this embodiment, the wet powder, which has reached the distal end portions of the kneading shaft members 13, 13, accumulates behind the first screen 61 so as to be kneaded, and then the wet powder drops into the second casing 81 through the discharge holes 65 of the first screen 61. That is, in the kneading and granulating apparatus 1 according to this embodiment, the raw material is caused to pass through the discharge holes 65 of the first screen 61, and hence the raw material is kneaded to a higher extent as compared to a case where the first screen 61 is not mounted on the opening portion of the distal end side of the first casing 11. This allows to obtain granules having a high hardness.

Further, in this embodiment, the blade 105, which is provided on the lower end portion 103 of the granulating shaft member 83, is divided at the plurality of positions. This allows to feed downward the wet powder, which has dropped into the second casing 81, without applying downward pressure to the extent possible.

FIG. 6 is a view illustrating a state in which a spacer is provided between the first casing and the first screen of the kneading and granulating apparatus of FIG. 1.

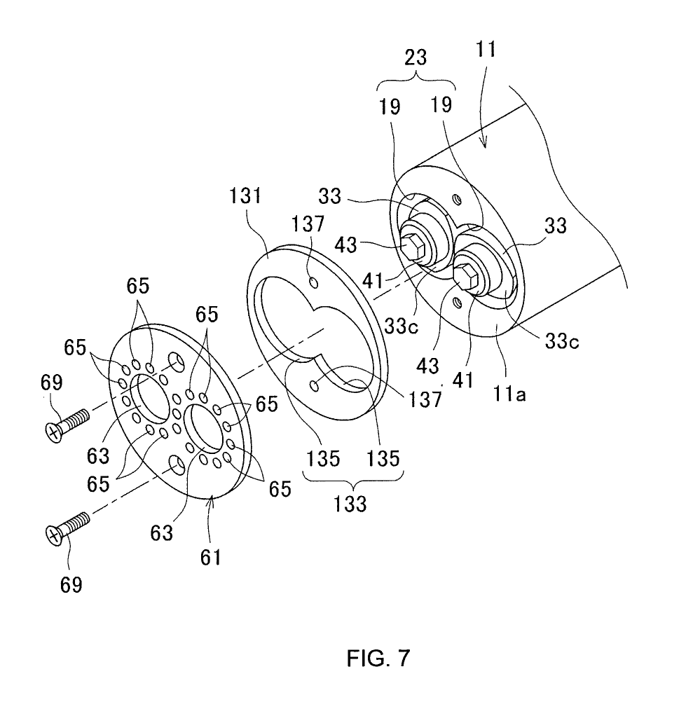

FIG. 7 is an exploded perspective view of the distal end portion of the kneading section of the kneading and granulating apparatus of FIG. 6.

In FIG. 1, the first screen 61 is assembled to the distal end surface 11a of the first casing 11 in an overlapping manner, and hence the distal end surface 11a of the first casing 11 and a plate surface 61a of the first screen 61 are held in direct contact with each other. On the other hand, in FIG. 6, an interval between the distal end surface 11a of the first casing 11 and the plate surface 61a of the first screen 61 can be changed. In other words, an interval between the distal end portion 33c of the piece 33 provided on the distal end portion of the shaft portion 31 and the first screen 61 can be changed.

Specifically, when a plate thickness of a spacer 131, which is mounted between the first casing 11 and the first screen 61, is changed, a separation distance between the first casing 11 and the first screen 61 can be changed.

The spacer 131 has a disc shape, and a through-hole 133 is formed in a center portion thereof. The spacer 131 has substantially the same shape in cross-section as the distal end portion of the first casing 11.

Specifically, two holes 135, 135 having a circular shape in cross-section are formed in the spacer 131 so as to extend in the axial direction. The two holes 135, 135 are formed so as to be adjacent to each other in the fore-and-aft direction, and also partially overlap with each other. Thus, the holes 135, 135 are integrally communicated to each other.

Thus, in the spacer 131, the through-hole 133 having substantially a shape of the figure of “eight” in the lateral direction is formed by the two holes 135, 135 so as to extend in the axial direction. The through-hole 133 has the same shape as the hole 23 of the first casing 11. Further, a through-hole 137 is formed in each of upper and lower end portions of the spacer 131.

The spacer 131 is arranged between the first casing 11 and the first screen 61.

Then, the screws 69 for fixing the first screen 61 to the first casing 11 are inserted through the through-holes 137, and thus the spacer 131 is fixed to the first casing 11.

The spacer 131 is provided, and thus a space is formed between the piece 33 provided on the distal end portion of the kneading shaft member 13 and the first screen 61. That is, a clearance corresponding to the thickness of the spacer 131 is secured between a distal end portion of a screw portion of the kneading shaft member 13 and the first screen 61.

With this, the raw material, which is kneaded by the kneading shaft member 13 while being conveyed by the kneading shaft member 13, temporarily accumulates in the clearance so as to be kneaded, and then the raw material is discharged from the discharge holes 65 of the first screen 61.

The spacer 131 is provided between the first casing 11 and the first screen 61, and thus the clearance is secured between the screw portion of the kneading shaft member 13 and the first screen 61. Therefore, the kneading is also carried out in the clearance, and hence is carried out to a higher extent as compared to a case where the spacer is not provided. Thus, this allows to obtain granules having a further higher hardness.

Considering the load applied to each kneading shaft member 13, it is preferred that the thickness of the spacer 131 be from 0.5 mm to 3.0 mm. Note that, in this embodiment, a diameter of the piece 33 (33B) of the kneading shaft member 13 is 23 mm, and a diameter of the hole 19 of the first casing 11 is 25 mm.

Further, it is preferred that a diameter of the discharge hole 65 of the first screen 61 be from 3 mm to 4 mm.

In this embodiment, the first screen 61 is provided on the distal end portion of the first casing 11. Therefore, the kneading is carried out to a higher extent, and thus the hardness of the granules can be increased.

Thus, a separation distance between the plate surface 61a of the first screen 61 and the distal end portion of the screw portion of the kneading shaft member 13, that is, the distal end portion 33c of the piece 33, which is provided on the distal end portion of the shaft portion 31, can be changed. Therefore, the hardness of the granules can be adjusted, and thus granules having a desired hardness can be obtained.

The kneading and granulating apparatus according to the present invention is not limited to the structure according to the above-mentioned embodiment, and may be modified as appropriate.

For example, in the above-mentioned embodiment, the spacer 131 is provided so as to change the interval between the distal end portion of the first casing 11 and the first screen 61. However, an outer circumferential portion of the first screen 61 may be projected into a tubular shape so as to change the interval. That is, the first screen 61 may be integrated with the spacer 131 as a single member. In this case, a plurality types of the first screen 61 having different lengths in the axial direction are prepared in advance, and a first screen having an appropriate length is selected. Then, the selected first screen is mounted on the distal end portion of the first casing 11.

What is claimed is:

1. A kneading and granulating apparatus, comprising:
a first casing;
a kneading shaft member arranged horizontally inside the first casing and rotatable so as to knead a raw material while conveying the raw material;
a first screen provided on a distal end portion of the first casing with a large number of holes formed in the first screen;
a second casing provided on the distal end portion of the first casing;
a second screen provided on a lower end portion of the second casing; and
a granulating shaft member arranged vertically inside the second casing and configured to granulate the raw material, which is fed through the first screen, in a portion between the granulating shaft member and the second screen,
wherein a separation distance between a distal end portion of a screw portion of the kneading shaft member in an axial direction of the kneading shaft member and a plate surface of the first screen is changeable.

2. A kneading and granulating apparatus according to claim 1, further comprising a plate-shaped spacer, which is provided between a distal end surface of the first casing and the plate surface of the first screen so as to change the separation distance between the distal end portion of the screw portion of the kneading shaft member in the axial direction and the plate surface of the first screen,
wherein the plate-shaped spacer has a hole formed therein at a position corresponding to a hole of the first casing, in which the kneading shaft member is arranged.

3. A kneading and granulating apparatus according to claim 2, wherein the first screen has a thickness of from 0.5 mm to 3.0 mm.

4. A kneading and granulating apparatus according to claim 1,
wherein the granulating shaft member has a round bar shape,
wherein a lower end portion of the granulating shaft member is formed so as to be increased in diameter,
wherein the granulating shaft member comprises a screw-shaped blade formed on an outer circumferential portion of the lower end portion thereof, and
wherein the screw-shaped blade is divided at a plurality of positions in a circumferential direction of the granulating shaft member.

5. A kneading and granulating apparatus according to claim 2,
wherein the granulating shaft member has a round bar shape,
wherein a lower end portion of the granulating shaft member is formed so as to be increased in diameter,
wherein the granulating shaft member comprises a screw-shaped blade formed on an outer circumferential portion of the lower end portion thereof, and
wherein the screw-shaped blade is divided at a plurality of positions in a circumferential direction of the granulating shaft member.

6. A kneading and granulating apparatus according to claim 3,
wherein the granulating shaft member has a round bar shape,
wherein a lower end portion of the granulating shaft member is formed so as to be increased in diameter,
wherein the granulating shaft member comprises a screw-shaped blade formed on an outer circumferential portion of the lower end portion thereof, and
wherein the screw-shaped blade is divided at a plurality of positions in a circumferential direction of the granulating shaft member.
